(19) United States
(12) Patent Application Publication
(10) Pub. No.: US 2005/0163987 A1
(43) Pub. Date: Jul. 28, 2005

(54) Oriented, thermoplastic polyester film capable of structuring by means of electromagnetic radiation, process for its production, and its use

(76) Inventors: Holger Kliesch, Mainz (DE); Thorsten Kiehne, Wiesbaden (DE); Gottfried Hilkert, Saulheim (DE); Franz Hora, Kriftel (DE)

Correspondence Address: PROPAT, L.L.C., 425-C SOUTH SHARON AMITY ROAD, CHARLOTTE, NC, 28211-2841, US

(21) Appl. No.: 11/037,689

(22) Filed: Jan. 18, 2005

(30) Foreign Application Priority Data
Jan. 27, 2004 (DE) 10 2004 003 891.0

(51) Int. Cl. B32B 27/18; B32B 27/36; B32B 31/30

(52) U.S. Cl. 428/220; 428/331; 428/336; 428/480; 428/910; 264/210.6; 264/211.12; 528/272

(57) ABSTRACT

The invention relates to a single- or multilayer, oriented film comprised of a polyester which comprises an additive which when irradiated with electromagnetic radiation forms metal nuclei on which further metal can be accumulated in further steps of the process. The film also comprises another, radiation-absorbing material. The invention further relates to a process for the production of this film and to its use in printed circuit boards, ribbon cables, smart cards, RFID labels, membrane keyboards, and film-based circuits of any type.

### CROSS-REFERENCE TO RELATED APPLICATIONS

This application claims priority to parent application no. 10 2004 003 891.01, filed in the Federal Republic of Germany on Jan. 27, 2004, hereby incorporated by reference herein in its entirety.

### FIELD OF THE INVENTION

The invention relates to a single- or multilayer, oriented film comprised of a polyester which comprises an additive which when irradiated with electromagnetic radiation forms metal nuclei on which further metal can be accumulated in further steps of the process. The film also comprises another, radiation-absorbing material. The invention further relates to a process for the production of this film and to its use in printed circuit boards, ribbon cables, smart cards, RFID labels, membrane keyboards, and film-based circuits of any type.

### BACKGROUND OF THE INVENTION

The use of polyester films for electrical insulation applications is known in art. There are ever-more-stringent requirements for circuits to achieve complexity in a small space, and these circuits have to be capable of rapid, flexible, and low-cost production, the result being a high level of technological requirements placed upon the film and on the steps of further processing.

Conventional processes for the production of flexible circuits mostly relate to full-surface metallization of the film web, or lamination of the film web to metal foil, and then structuring of the resultant conductive surfaces by various methods, e.g. etching or mechanical removal of the undesired amounts of metal. There are also processes which apply the metal by stamping or printing, or a conductive paste comprised of carbon/silver is applied. Disadvantages of these processes are their low flexibility and precision, the result being a relatively large separation between the conductor tracks and/or the high costs associated with these processes, and/or the low production speeds.

EP-A-1 274 288 describes a process which, starting from copper-containing metal oxides, copper nuclei are formed via laser irradiation, and further copper is deposited onto these in a subsequent electroplating step. That specification describes exclusively injection moldings, and no indication is given as whether and how the process can be applied for polyester films and films generally. In particular, there is no indication as to what types of polymers and additives are required to produce oriented films. The PBT/SiO₂/spinel compounded material described in EP-A-1 274 288 is unsuitable for the production of oriented films, because the polybutylene terephthalate used has a high crystallization rate and a high fumed silica filler level, and is therefore not capable of reliable processing.

In particular, there is no indication as to how it is possible to produce a film with adequate dimensional stability under conditions of local heating after irradiation with electromagnetic radiation and further processing.

Another problem with films, due to low layer thickness, is that the absorption of radiation is insufficient, and therefore the amount of energy absorbed can sometimes be insufficient, to initiate the conversion of the metal salts into the elemental metals. A very high concentration of the activatable metal compounds therefore has to be added, and this is undesirable in the case of heavy metal compounds such as copper compounds, for environmental reasons.

### SUMMARY OF THE INVENTION

It is an object of the present invention to provide a film which does not have the disadvantages mentioned and which comprises a compound which is capable of activation by radiation and which forms metal nuclei on which further metal can be accumulated in further steps of the process. This film is also not only to be capable of cost-effective production and have good orientability but also is to have good mechanical properties, i.e. a high longitudinal and transverse modulus of elasticity, and also defined shrinkage.

### BRIEF DESCRIPTION OF THE DRAWINGS

FIG. 1 is a graphical illustration of an exemplary cumulative particle size distribution curve.

### DETAILED DESCRIPTION OF THE INVENTION

This object is achieved via a single- or multilayer, at least monoaxially stretched thermoplastic polyester film with a thickness of from 5 to 500 μm, which comprises
a) from 0.5 to 15% by weight of a metal compound capable of activation by electromagnetic radiation, and
b) an amount of from 0.1 to 15% by weight, in each case based on the film, of a material which absorbs radiation.

The thickness of the film is preferably from 12 to 200 μm, and in particular from 30 to 150 μm, and the film preferably comprises from 1.5 to 10% by weight, and in particular from 2 to 8% by weight, of component a), and preferably from 0.5 to 5% by weight, and in particular from 0.8 to 2% by weight, of component a).

The compound a) capable of activation by radiation is a metal-containing (inorganic or organic) compound which as a consequence of absorption of electromagnetic radiation liberates metal in elemental form, in a chemical reaction. This chemical reaction may also take place with participation of other reactants. It is also possible that the electromagnetic radiation is not directly absorbed by the metal-containing compound, but is absorbed by other substances which then transfer the absorbed energy to the metal-containing compound and thus bring about the liberation of elemental metal. The electromagnetic radiation may be UV light (wavelength from 100 to 400 nm), visible light (wavelength from 400 to 800 nm), or infrared light (wavelength from 800 to 25 000 nm). Other preferred forms of radiation are X-rays, gamma rays, and particle beams (electron beams, α-particle beams, and β-particle beams).

The deposition of further metal onto the metal nuclei generated by electromagnetic radiation preferably takes place via electroplating (solution-chemistry) processes.

Good orientability includes excellent capability of the film to undergo monoaxial or biaxial orientation, without break-offs, during its production.

Good mechanical properties include high modulus of elasticity in at least one film direction (longitudinal direction (MD) and/or transverse direction (TD)), of greater than or equal to (≧) 500 N/mm², preferably greater than or equal to (≧) 2000 N/mm² and particularly preferably greater than or equal to (≧) 4000 N/mm².

In one preferred embodiment, the film of the invention has no shrinkage >25% in any film direction (MD or TD) at 200° C. Shrinkage at 200° C. is preferably less than or equal to (≦) 15%, in particular less than or equal to (≦) 5%.

The inventive film comprises, as main polymer constituent (i.e. to an extent of from 55 to 100% by weight, preferably from 70 to 100% by weight, and particularly preferably from 90 to 100% by weight), a thermoplastic polyester.

According to the invention, a thermoplastic polyester is
homopolyester
copolyester
blends of various polyesters,
   and these may be used either in the form of pure polymers or else in the form of polyesters comprising recycled material.

Polyesters contain repeat units which derive from dicarboxylic acids (100 mol %) and from diols (likewise 100 mol %) . The inventive polyesters are preferably based on terephthalic acid or 2,6-naphthalenedicarboxylic acid as dicarboxylic acid and on ethylene glycol or 1,4-butanediol as diol (PET, PBT and PEN).

In particular, the inventive polyesters contain from 10 to 100 mol % of terephthalate or from 10 to 100 mol % of 2,6-naphthalate as dicarboxylic acid components (the total amount of dicarboxylic acid components making up 100 mol %). Other dicarboxylic acid components which may be present in the inventive polyester are from 0 to 50 mol % of 2,6-naphthalate (if terephthalate was used as main component), from 0 to 50 mol % of terephthalate (if naphthalate was used as main component), from 0 to 20 mol % of isophthalate (preferably from 0.5 to 4 mol.%), and also from 10 to 60 mol % of 4,4′-diphenyldicarboxylate. Other dicarboxylic acid components, such as 1,5-naphthalenedicarboxylate, should not exceed a proportion of 30 mol %, preferably 10 mol %, in particular 2 mol %.

As diol component, the inventive polyester contains from 10 to 100 mol % of ethylene glycol (EG) (the entire amount of diol components making up 100 mol %). If mixtures of different diols are used, then advantageously the proportion of diethylene glycol should not exceed 10 mol %, and is ideally from 0.5 to 5 mol %. Other diol components, such as cyclohexanedimethanol, 1,3-propanediol, 1,4-butanediol should advantageously not exceed a proportion of 50 mol %, their proportion preferably being less than 30 mol %, particularly preferably less than 10 mol %.

Alongside the main polymer constituents mentioned, up to 45% by weight, preferably up to 30% by weight, particularly preferably up to 20% by weight, based on the weight of the film, of other polymers, such as polyetherimides (e.g. ULTEM® 1000 from GE Plastics Europe (NL)), polycarbonates (e.g. MAKROLON® from Bayer (DE)), polyolefins, such as COCs (e.g. TOPAS® from Ticona (DE)), polyamides (ULTRAMID® from BASF, (DE)), inter alia, may be present in other embodiments of the film.

The polyesters mentioned may also be used as mixtures.

The polyesters are generally prepared by processes known from the literature, from the diols -mentioned and dicarboxylic acid or dicarboxylic ester. The polyesters may be prepared either by the transesterification process, using the usual catalyst, such as salts of Zn, of Ca, of Li or of Mn, or by the direct esterification process.

The inventive film is either a single-layer or multilayer film. The multilayer films have at least two layers and are comprised of a base layer B, and of at least one outer layer A or C, and, if appropriate, other intermediate layers, preference being particularly given to a three-layer A-B-A or A-B-C structure. For this embodiment it is advantageous for the melt viscosity of the polymer of the base layer B to be similar to that of the outer layer(s) adjacent to the base layer.

The thickness of the outer layer(s) is selected independently of the other layers, and is in the range from 0.1 to 10μm, preferably from 0.2 to 5 μm, in particular from 1 to 3μm, and the thickness and constitution of outer layers applied on the two sides may be identical or different. The thickness of the base layer is correspondingly calculated from the difference between the total thickness of the film and the thickness of the outer and intermediate layer(s) applied, and may therefore vary similarly to the total thickness, within wide limits.

The compound a) capable of activation by radiation is comprised of electrically non-conductive, high-thermal-stability, organic or inorganic metal compounds. Compounds of this type are described in EP-A-1 274 288. Preference is given here to compounds of metals of the d and f group of the Periodic Table of the Elements with non-metals. The metal-containing compounds are particularly preferably metal oxides, in particular monooxides of the d-metals of the Periodic Table of the Elements. Higher metal oxides are particularly suitable. In one particularly preferred embodiment of the invention, the higher oxides are spinels, in particular copper-containing spinels, such as CuCr₂O₄. Suitable copper-containing spinels are commercially available, an example being PK 3095 from Ferro (DE) or 34E23 or 34E30 from Johnson Matthey (DE). Copper oxides of the formula CuO or Cu₂O are also particularly suitable, and use is preferably made here of nanoparticles, such as NANOARC® Copper Oxide from Nanophase Technologies Corporation, Illinois, USA.

The concentration of these compounds present in the inventive film is from 0.5 to 15% by weight, preferably from 1.0 to 10% by weight, and particularly preferably from 2 to 8% by weight.

If the metal-containing compound a) is not soluble in the polyester used for the production of the film, the particles have an average size (d₅₀ value) of from 0.01 to 20 μm, preferably from 0.02 to 5 μm, and particularly preferably from 0.05 to 3 μm.

Besides the compound a) capable of activation by radiation, the inventive film may comprise other particulate additives, such as fillers and antiblocking agents. Typical fillers and antiblocking agents are inorganic and/or organic particles, such as silicon dioxide (natural, precipitated, or fumed), calcium carbonate, magnesium carbonate, barium carbonate, calcium sulfate, barium sulfate, lithium phosphate, calcium phosphate, magnesium phosphate, titanium dioxide (rutile or anatase), kaolin (hydrated or calcined), aluminum oxide, aluminum silicates, lithium fluoride, the calcium, barium, zinc, or manganese salts of the dicarboxylic acids used, or crosslinked polymer particles, e.g. polystyrene or polymethyl methacrylate particles, preferably silicon dioxide.

It is also possible to select mixtures of two or more of the abovementioned particle systems or mixtures of particle systems with the same chemical composition but different particle size. The particles are advantageously added to the polyester before melting begins.

If, besides the compound a) capable of activation by radiation, other particulate additives are present in the film, the total concentration of these particles is less than 20% by weight, based on the total weight of the film, preferably less than 15% by weight, and particularly preferably less than 5% by weight. The particulate additives have an average size (d₅₀ value) of from 0.01 to 15 μm, preferably from 0.03 to 10 μm, and particularly preferably from 0.05 to 1 μm. In one preferred embodiment, the proportion of particles with d₅₀ more than or equal to (≧) 3 μm is less than or equal to (≦) 2000 ppm, and particularly preferably less than or equal to (≦) 1000 ppm.

It has been found that even films without other particulate additives (other than the metal component capable of activation by radiation) can be used in the invention. However, formation of the metal nuclei is improved if the film comprises silicon dioxide as filler within the particle sizes and maximum amounts mentioned above. For formation of the metal nuclei it has proven particularly advantageous for the film to comprise from 0.1 to 20% by weight, preferably from 0.5 to 15% by weight, and particularly preferably from 1 to 5% by weight, of silicon dioxide particles with d₅₀ less than or equal to (≦) 1 μm.

Al₂O₃ (e.g. AEROXIDE® Alu C from Degussa (DE)) may also be used as an alternative to SiO₂. The amounts and particle sizes are the same as those mentioned in the previous paragraph for SiO₂.

One preferred embodiment of the inventive film comprises, alongside the metal compound a) capable of activation by radiation, if appropriate, based on the film, an amount of from 0.1 to 15% by weight, preferably from 0.5 to 5% by weight, and particularly preferably from 0.8 to 2% by weight, of another, radiation-absorbing material b) . This material preferably absorbs in the wavelength range of the radiation source used to form the metal nuclei.

Preferred materials here are graphite or carbon black, or inorganic or organic black pigments, such as Pigment Black 26 (e.g. Fe₂O₃/MnO₂/SiO₂/Al₂O₃ from Anirox Pigments Limited (IN)) or aniline black from Degussa (DE). In the case of carbon blacks and graphites it is advantageous to use grades with low conductivity, such as SPEZIALSCHWARZ® 4 or AEROSPACE® 15 from Degussa (DE).

It is advantageous that components a) and b) are always found together in at least one of the layers of the film. However, separate use in various layers is also possible. However, care has to be taken that the quantities of the components used are within the stated limits.

The inventive film may comprise other additives, such as UV stabilizers, flame retardants, hydrolysis stabilizers, and antioxidants, and in particular UV stabilizers, such as TINUVIN® from Ciba (CH) also contribute here to improved formation of metal nuclei if use is made of a UV radiation source, because they effectively absorb the energy of the incident UV radiation.

In another embodiment, the inventive film is flame-retardant. Flame-retardant means that in what is known as a fire protection test to UL94 VTM the film achieves at least the classification VTM-2. The film then comprises a flame retardant at a concentration in the range from 0.2 to 30% by weight, preferably from 0.5 to 25% by weight, particularly preferably from 1 to 20% by weight, based on the weight of the film. It is important that the flame retardant is soluble in the polyester, because otherwise the required mechanical properties are not achieved. Examples of suitable flame retardants are organic bromine, chlorine, or nitrogen compounds, or metal hydroxides or metal oxide trihydrates. However, the halogen compounds have the disadvantage that toxic and corrosive hydrogen halides are produced in the event of a fire. Another disadvantage is the low light-resistance of a film equipped therewith. Examples of other suitable flame retardants are organophosphorus compounds, such as carboxyphosphinic acids, their anhydrides, and dimethyl methanephosphonate. Very suitable flame retardants here are those in which the phosphorus compound has chemical bonding to the polyester. Very particular preference is given to bis(2-hydroxyethyl)[(6-oxido-6H-dibenzo[c,e]-[1,2]oxaphosphorin-6-yl)methyl]butanedicarboxylate of the formula

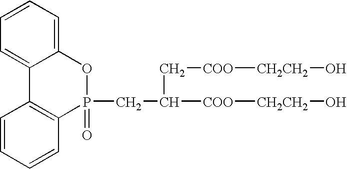

In this preferred embodiment, the inventive low-flammability film comprises, besides the polyester, the compound capable of activation by radiation, and, if appropriate, particulate additives, from 1 to 20% by weight of an organophosphorus compound as flame retardant soluble in the polyester.

Because the flame retardants generally have some susceptibility to hydrolysis, it may be advisable to add a hydrolysis stabilizer. Examples of suitable hydrolysis stabilizers are polymeric carbodiimides, e.g. STABAXOL P® from Rheinchemie (DE). The amount of these preferably used is from 0.1 to 1% by weight (based on the weight of the film).

The abovementioned proportions of flame retardant and hydrolysis stabilizer have also proven advantageous when the main constituent of the film is not polyethylene terephthalate, but another polyester.

The compound a) capable of activation by radiation, and also the radiation-absorbing compound b), and any other additives used, such as particles, UV stabilizers, flame retardants, hydrolysis stabilizers, and antioxidants, may be added in the form of a glycolic dispersion during the polycondensation process to the polyester used for the production of the inventive film. However, it is preferable to add the component capable of activation by radiation and/or any other additives used by way of masterbatches to the polyester during film extrusion.

The film may also be coated to establish other properties. Particularly typical coatings are layers with adhesion-promoting, antistatic, slip-improving, or release action. Clearly, these additional layers may be applied to the film by way of in-line coating by means of aqueous dispersions after the longitudinal stretching and prior to the transverse stretching.

In one particular embodiment, at least one side of the film has a silicone coating, e.g. as described in U.S. Pat. No. 5,728,339. This embodiment has the advantage that after the laser treatment the surrounding regions have protection from the corrosive action of the electro-plating bath, and that residues of the electroplating solution can be removed more easily from the film surface.

For certain applications, it can be advantageous to pretreat the surface of the film chemically, using an acid. For this “adhesion-promoting etch” particularly suitable compounds are trichloroacetic acid, dichloro-acetic acid, or hydrofluoric acid, which act on the surface for a short time (from 5 to 120 seconds) and then are removed by means of an air knife. This gives the film a very reactive, amorphous surface.

The additives, i.e. the metal compound a) capable of activation by radiation, and the component b), and also any other fillers and other additives present, may be introduced into the polymer by means of a commercially available twin-screw extruder. Here, inventive polyester pellets are introduced into the extruder together with the particles/additives and extruded, then quenched in a water bath, and then pelletized.

However, in one preferred process for preparing the inventive polyesters, the additives are added directly during the preparation of the polyester. In the case of the DMT process, the additives are usually added in the form of a glycolic dispersion after the transesterification or directly prior to the poly-condensation (e.g. by way of the transport line between transesterification and polycondensation vessels). However, the addition may also take place prior to the start of the transesterification. In the case of the TPA process, the addition preferably takes place at the start of the polycondensation. However, later addition is also possible. In the case of this process it has proven advantageous to filter the glycolic dispersions through a PROGAF PGF 57 (Hayward (Indiana, USA)) filter prior to addition.

The present invention also provides a process for the production of the film. The general production method involves an extrusion process, for example on an extrusion line. It has proven particularly advantageous to add component a) capable of activation by radiation and the material b) which absorbs radiation, and also any other additives used, such as particles, UV stabilizers, flame retardants, hydrolysis stabilizers, and anti-oxidants, in the amounts mentioned, in the form of predried or precrystallized masterbatches prior to the extrusion process.

In masterbatch technology it is preferable that the particle size and the bulk density of the masterbatches are similar to the particle size and the bulk density of the polyester used, thus achieving homogeneous dispersion, resulting in homogeneous properties.

The polyester films may be produced in the form of a single-layer or multilayer film by known processes from a polyester and, if appropriate, from other raw materials, at least one component capable of activation by radiation, and also, if appropriate, other additives.

Masterbatches which comprise the component capable of activation by radiation have preferably been pre-crystallized and/or predried. The same applies to masterbatches which comprise particles, UV stabilizer(s), flame retardants, and/or other additives. The predrying includes progressive heating of the masterbatches under reduced pressure (from 20 to 80 mbar, preferably from 30 to 60 mbar, in particular from 40 to 50 mbar), with stirring, and, if appropriate, afterdrying at a constant elevated temperature (likewise under reduced pressure). It is preferable for the masterbatches to be charged batchwise at room temperature from a feed vessel in the desired blend together with the polyester and, if appropriate, with other raw material components into a vacuum dryer in which the temperature profile moves from 10 to 160° C., preferably from 20 to 150° C., in particular from 30 to 130° C., during the course of the drying time or residence time. During the residence time of about 6 hours, preferably 5 hours, in particular 4 hours, the raw material mixture is stirred at from 10 to 70 rpm, preferably from 15 to 65 rpm, in particular from 20 to 60 rpm. The resultant precrystallized or predried raw material mixture is afterdried in a downstream vessel, likewise evacuated, at temperatures of from 90 to 180° C., preferably from 100 to 170° C., in particular from 110 to 160° C., for from 2 to 8 hours, preferably from 3 to 7 hours, in particular from 4 to 6 hours.

The masterbatches, and also the other raw materials, may also be directly extruded without predrying if use is made of twin- or multiscrew extruders.

In the preferred coextrusion process for the production of the film, the melts corresponding to the individual layers of the film are extruded through a flat film die and quenched in the form of a substantially amorphous prefilm on a chill roll. In the case of the single-layer film of the invention, only one melt is extruded through the die. This film is then reheated and oriented in at least one direction, or longitudinally and transversely, or transversely and longitudinally, or longitudinally, transversely, and again longitudinally and/or transversely. The film temperatures in the stretching process are generally above the glass transition temperature Tg of the polyester used by from 10 to 60 C, and the longitudinal stretching ratio is usually from 2 to 6, in particular from 3 to 4.5, the transverse stretching ratio usually being from 2 to 5, in particular from 3 to 4.5, the ratio for any second longitudinal and transverse stretching carried out usually being from 1.1 to 5. The first longitudinal stretching may also be carried out simultaneously with the transverse stretching (simultaneous stretching). The heat-setting of the film follows at oven temperatures of from 180 to 260° C., in particular from 220 to 250° C. The film is then cooled and wound.

In one preferred embodiment, the heat-setting takes place at temperatures of from 220 to 250° C., and the film is relaxed transversely at this temperature by at least 1%, preferably at least 2%.

In another preferred embodiment, the heat-setting takes place at temperatures of from 220 to 250° C., and the film is relaxed transversely at this temperature by at least 1%, preferably at least 2%, and then again transversely relaxed, again by at least 1%, preferably at least 2%, at temperatures of from 180 to 150° C. in the cooling phase.

In another preferred embodiment, the film is stretched in MD and TD by a factor of at least 3, this stretching taking place in a simultaneous frame. The heat-setting takes place at from 220 to 250° C., and the film is longitudinally and transversely relaxed by at least 1% at this temperature.

The inventive single-layer or multilayer films have the required good mechanical properties. For example, the modulus of elasticity in at least one direction of the film (longitudinal direction (MD) and/or transverse direction (TD)) is greater than or equal to (≧) 500 N/mm², preferably greater than or equal to (≧) 2000 N/mm², and particularly preferably greater than or equal to (≦) 4000 N/mm².

The inventive multilayer film has no shrinkage greater than 25% at 200° C. in any film direction (either MD or TD). Indeed, shrinkage at 200° C. is less than or equal to (≦) 15% and preferably less than or equal to (≦) 5%.

The combination of properties of the inventive films makes them suitable for a wide variety of applications, for example for printed circuit boards, ribbon cable, smart cards, RFID labels, membrane keyboards, and film-based circuits of any type.

The individual properties were measured here to the following standards or by the following methods:

Test Methods

Mechanical Properties

Modulus of elasticity, ultimate tensile strength, tensile strain at break, and F₅ value are measured longitudinally and transversely to ISO 527-1-2 with the aid of tensile strain measurement equipment (010, Zwick (Ulm, DE)).

Shrinkage

Thermal shrinkage was determined on square film samples with an edge length of 10 cm. The specimens were measured precisely (edge length L₀) and heat-conditioned for 15 minutes at 200° C. in a convection oven, and then measured precisely at room temperature (edge length L). Shrinkage is given by the equation
shrinkage [%]=100·(L_{O}−L)/L_{O}
Measurement of Average Diameter d₅₀

Average diameter d₅₀ was determined by means of a laser on a Malvern Mastersizer by the standard method (an example of other measurement equipment being the Horiba LA 500 or Sympathec Helos, which use the same principle of measurement). For this, the specimens were placed with water in a cell, which was then placed in the measurement equipment. The measurement procedure is automatic and also include the mathematical determination of the d₅₀ value.

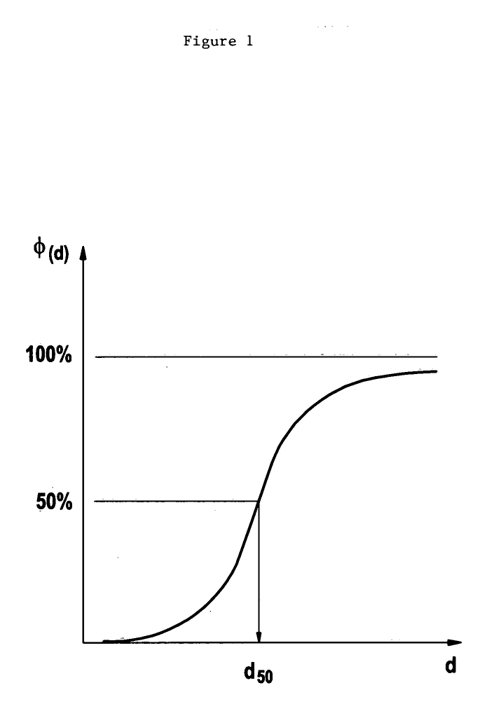

The d₅₀ value here is defined as the value determined from the (relative) cumulative particle size distribution curve: the point of intersection of the 50% ordinate value with the cumulative curve immediately gives the desired d₅₀ value on the abscissa axis. FIG. 1 provides further illustration of what is meant here.

Film Production

Polymer chips were mixed in the ratios stated in the examples and in each case were melted in twin-screw extruders, without predrying. The molten polymer extrudates were combined in a coextrusion die and drawn off by way of a take-off roll (roll temperature 20° C.). The film was stretched by a factor of 3.5 in the machine direction at 116° C. (film temperature in the stretching gap), and transverse stretching by a factor of 3.2 was carried out in a frame at 110° C. The film was then heat-set at 229° C. and relaxed transversely by 1% at temperatures of from 229 to 200° C. and again by 1% at temperatures of from 180 to 150° C. The production speed (final film speed) was 300 m/min. Final film thickness: 100 μm.

### EXAMPLES

The following raw materials are used in the examples:

Masterbatch MB1

15% by weight of PK3095 from Ferro and 85% by weight of polyethylene terephthalate RT49 (PET) from Kosa (DE)

Masterbatch MB2

10% by weight of AEROXIDE® Alu C Al₂O₃ from Degussa (DE) (d₅₀ of agglomerates about 300 nm; primary particle d₅₀ about 50 nm) and 90% by weight of polyethylene terephthalate RT49 (PET)

Masterbatch MB3

15% by weight of NANOARC® Copper Oxide CuO nanoparticles from Nanophase Technologies Corporation, Illinois, USA, and 85% by weight of polybutylene terephthalate (PBT)

Masterbatch MB4

15% by weight of Pigment Black 26 (Fe₂O₃/MnO₂/SiO₂/Al₂O₃) from Anirox Pigments Limited (IN) and 85% by weight of polyethylene terephthalate RT49 (PET)

Masterbatch MB5

15% by weight of SPEZIALSCHWARZ® 4 from Degussa (DE) and 85% by weight of polyethylene terephthalate RT49 (PET)

Polymer P1

100% by weight of polyethylene terephthalate RT49

Polymer P2

25% by weight of AEROSIL® 90 from Degussa (DE), 5% by weight of PK3095 from Ferro and 70% by weight of polybutylene terephthalate (PBT)

Polymer P3

100% by weight of polybutylene terephthalate (PBT)

Polymer P4

100% by weight of polyethylene naphthalate (PEN)

### Example 1

An ABC film with a base layer thickness of 94 μm and 3 μm for each of the outer layers A and C was produced as stated above.

Raw material mixture for outer layer A: 50% by weight of MB1; 10% by weight of MB2; 10% by weight of MB4; 30% by weight of P1

Raw material mixture for base layer B: 100% by weight of P1

Raw material mixture for outer layer C: 20% by weight of MB2; 80% by weight of P1

### Example 2

Inventive example 1 was repeated. However, recycled material which was produced from the film of inventive example 1 was also added to the base layer B.

Raw material mixture for base layer B: 50% by weight of P1; 50% by weight of recycled material

### Example 3

Inventive example 1 was repeated with the following changes:

Raw material mixture for outer layer A: 50% by weight of MB3; 10% by weight of MB2; 10% by weight of MB5; 30% by weight of P1

Raw material mixture for base layer B: 100% by weight of P1

Raw material mixture for outer layer C: 20% by weight of MB2; 80% by weight of P1

### Example 4

Inventive example 1 was repeated with the following changes:

Raw material mixture for outer layer A: 50% by weight of MB1; 10% by weight of MB2; 10% by weight of MB5; 20% by weight of P1; 10% by weight of P4

Raw material mixture for base layer B: 100% by weight of P1

Raw material mixture for outer layer C: 20% by weight of MB2; 80% by weight of P1

### Example 5

An ABC film as in inventive example 1 was produced from the following components:

Raw material mixture for outer layer A: 50% by weight of MB1; 10% by weight of MB2; 10% by weight of MB5; 20% by weight of P1; 10% by weight of P4

Raw material mixture for base layer B and outer layer C=raw material mixture for outer layer A

The properties of the films of inventive examples 1-5 may be found in the table.

### Comparative Example 1

An attempt was made to use the polymer P2 (based on the polymer from the example in EP-A-1 274 288) to produce, as stated above, an ABA film with a base layer thickness of 46 μm and 2 μm for each of the outer layers A.

Raw material mixture for outer layer A: 100% by weight of P2

Raw material mixture for base layer B: 100% by weight of P2

Orientation of the film proved to impossible, because every attempt at stretching led to break-off. It was impossible to produce a film.

### Comparative example 2

Raw material mixture for outer layer A: 50% by weight of MB1; 10% by weight of MB2; 40% by weight of P1

Raw material mixture for base layer B: 100% by weight of P1

Raw material mixture for outer layer C: 20% by weight of MB2; 80% by weight of P1

### Comparative Example 3

Inventive example 1 was repeated. However, the heat-setting did not take place as stated above at 229° C., but at 150° C., and no relaxation took place.

The properties of the films from comparative examples 2 and 3 can be seen in the table.

Conductor Track Production

In the region of the conductor tracks to be applied, the films produced were irradiated by a laser (triple-frequency Nd:YAG laser (λ=355 nm) from LPKF AG (DE)), at an intensity which generates a very small amount of ablation, associated with structured nucleation. After brief treatment in an ultrasound cleaning containing demineralized water, the film is passed through a commercially available chemically reductive copper-plating bath. Here, the conductor tracks are constructed in the irradiated regions. Ablation was from 0.5 to 1.0 μm.

Results of Conductor Track production

The conductor tracks generated were assessed visually by means of an optical microscope (incident light) at 20× magnification. The coherence of the copper layer was evaluated visually and allocated to the following categories: good, less good, and poor.

TABLE

| | MD modulus | TD modulus | MD | TD | |
|---|---|---|---|---|---|
| | of elasticity in | of elasticity in | shrinkage | shrinkage | Conductor track |
| | n/mm² | n/mm² | at 200° C. | at 200° C. | production |
| Example | | | | | |
| 1 | 4300 | 5400 | 4.9 | 1.8 | good-very good |
| 2 | 4400 | 5100 | 4.4 | 2.1 | good-very good |
| 3 | 4200 | 5200 | 4.5 | 2 | good-very good |
| 4 | 4100 | 5300 | 4.2 | 1.9 | very good |
| 5 | 3900 | 4700 | 4.1 | 1.5 | very good |
| Comparative | | | | | |
| example | | | | | |
| 1 | no film | no film | no film | | no film obtained |
| | obtained | obtained | obtained | | |
| 2 | 4100 | 5200 | 4.3 | 2.1 | moderate*) |
| 3 | 4700 | 5900 | 19 | 22 | moderate**) |

*)If the intensity and irradiation time were the same as in inventive examples 1-5, conductor track quality was markedly poorer to inadequate. However, if the irradiation time was increased good values could be achieved.
**)If the intensity and irradiation time were the same as in inventive examples 1-5, conductor track quality was markedly poorer to inadequate. However, if the irradiation time was increased by a factor of 2 it was possible to achieve good values for conductor track quality. However, creases formed after laser irradiation.

1. A single- or multilayer at least monoaxially stretched thermoplastic polyester film with a thickness of from about 5 to 500 μm, which comprises, based in each case on the film,
a) from about 0.5 to 15% by weight of a metal compound capable of activation by electromagnetic radiation, and
b) an amount of from about 0.1 to 15% by weight of a material which absorbs radiation.

2. The film as claimed in claim 1, whose thickness is from about 12 to 200 μm and which comprises from about 1.5 to 10% by weight of component a) and from about 0.5 to 5% by weight of component b), based in each case on the film layer.

3. The film as claimed in claim 1, wherein the thermoplastic polyester comprises polyethylene terephthalate, polybutylene terephthalate, poly-ethylene naphthalate, or a mixture thereof.

4. The film as claimed in claim 1, wherein the metal compound a) capable of activation by radiation is an electrically non-conducting organic or inorganic compound with high thermal stability.

5. The film as claimed in claim 1, wherein the material b) which absorbs radiation is graphite, carbon black, inorganic black pigment or organic black pigment.

6. The film as claimed in claim 1, further comprising other particulate additives.

7. The film as claimed in claim 17, which comprises from about 0.1 to 20% by weight of silicon dioxide particles whose d₅₀ value is less than or equal to about 1 μm.

8. The film as claimed in claim 1, which has at least two layers and comprises at least a base layer and an outer layer, with optional intermediate layers.

9. The film as claimed in claim 8, which has an A-B-A or A-B-C three-layer structure.

10. The film as claimed in claim 8, wherein the thickness of the outer layer(s) is in the range from about 0.1 to 10 μm, and the thickness of the base layer is calculated from the difference between the total thickness of the film and the thickness of the outer and optional intermediate layer(s).

11. The film as claimed in claim 1, which has a modulus of elasticity in at least one film direction (longitudinal direction (MD) and/or transverse direction (TD)) of greater than or equal to about 500 N/mm².

12. The film as claimed in claim 1, which comprises a recycled polymer.

13. A process for producing a single- or multilayer at least monoaxially stretched thermoplastic polyester film with a thickness of from 5 to 500 μm, which comprises extruding through a flat-film die melt(s) corresponding to the individual layer(s) of the film, where at least one of the layers comprises a metal compound a) capable of activation by electromagnetic radiation and further comprises a material b) which absorbs radiation, cooling the resultant film, reheating it, and then orienting it in at least one direction, and then heat-setting it.

14. The process as claimed in claim 13, wherein the amount of component a) added is from about 0.5 to 15% by weight and the amount of component b) added is from about 0.1 to 15% by weight, based in each case on the film, and wherein the addition takes place by way of masterbatch technology.

15. Printed circuit boards, ribbon cables, smart cards, RFID labels, membrane keyboards, or film-based circuits comprising film according to claim 1.

16. A film according to claim 4, wherein the metal compound a) is a metal oxide or a spinel.

17. A film according to claim 6, wherein the other particulate additive is silicon dioxide.
